(19) United States
(12) Patent Application Publication
(10) Pub. No.: US 2017/0263198 A1
(43) Pub. Date: Sep. 14, 2017

(54) SYSTEM AND METHOD FOR ADJUSTING LUMINANCE OF A DISPLAY SCREEN

(71) Applicant: BOE TECHNOLOGY GROUP CO., LTD., Beijing (CN)

(72) Inventors: Huizhong ZHU, Beijing (CN); Junguo LIU, Beijing (CN); Moyu ZHU, Beijing (CN)

(21) Appl. No.: 15/207,746

(22) Filed: Jul. 12, 2016

(30) Foreign Application Priority Data
Mar. 8, 2016 (CN) 201610130647.5

(51) Int. Cl. G09G 3/36

(52) U.S. Cl. CPC G09G 3/3607; G09G 2360/147; G09G 2320/0673; G09G 2320/0233

(57) ABSTRACT

The present disclosure provides a system and method for adjusting luminance of a display screen, the method comprising: obtaining a current luminance value of each pixel in a preset grayscale image of a display screen, wherein the preset grayscale is any grayscale lower than a preset grayscale threshold; determining a target luminance value of each pixel; adjusting luminance of some or all of the pixels according to the current luminance value and the target luminance value of each pixel, so that a luminance value of each pixel reaches the target luminance value.

### CROSS-REFERENCE TO RELATED APPLICATION

This application claims the benefit and priority of Chinese Patent Application No. 201610130647.5 filed Mar. 8, 2016. The entire disclosure of the above application is incorporated herein by reference.

### FIELD

The present disclosure relates to the field of display technologies, including a system and method for adjusting luminance of a display screen.

### BACKGROUND

This section provides background information related to the present disclosure which is not necessarily prior art.

Currently there is a more widespread obvious defect in liquid crystal display screens, that is, images with lower luminance have worse luminance uniformity so that liquid crystal display screens cannot accurately restore true image information, so there is possibility to mislead control personnel.

### SUMMARY

This section provides a general summary of the disclosure, and is not a comprehensive disclosure of its full scope or all of its features.

Exemplary embodiments of the present disclosure provide a system and method for adjusting luminance of a display screen, to enhance uniformity of display luminance of a liquid crystal display screen, so that the liquid crystal display screen can accurately restore true image information.

According to a first aspect of embodiments of the present disclosure, there is provided a method for adjusting luminance of a display screen, comprising:

obtaining a current luminance value of each pixel in a preset grayscale image of the display screen, wherein the preset grayscale is any grayscale lower than a preset grayscale threshold;

determining a target luminance value of each pixel;

adjusting luminance of some or all of the pixels according to the current luminance value and the target luminance value of each pixel, so that a luminance value of each pixel reaches the target luminance value.

According to an exemplary embodiment, after adjusting luminance of some or all of the pixels so that a luminance value of each pixel reaches the target luminance value, the method further comprises:

repeating the following steps until a display effect of the display screen meets a preset display effect:

judging whether the display effect of the display screen meets the preset display effect; if not, then re-obtaining a current luminance value of each pixel in a preset grayscale image of the display screen, re-determining a target luminance value of each pixel, and adjusting luminance of some or all of the pixels according to the re-obtained current luminance value of each pixel and the re-determined target luminance value, so that a luminance value of each pixel reaches the re-determined target luminance value.

According to an exemplary embodiment, the preset grayscale threshold is any one of L6˜L10.

According to an exemplary embodiment, said obtaining a current luminance value of each pixel in a preset grayscale image of a display screen comprises:

setting a number of pixels collected by a CCD camera according to a resolution of the display screen;

collecting a current luminance value of each pixel of the display screen by utilizing the set CCD camera.

According to an exemplary embodiment, said determining a target luminance value of each pixel comprises:

determining a current maximum luminance value according to the current luminance value of each pixel of the display screen, and taking the current maximum luminance value as the target luminance value of each pixel.

According to an exemplary embodiment, said determining a target luminance value of each pixel comprises:

obtaining a current average luminance value of the pixels according to the current luminance value of each pixel of the display screen, and taking the average luminance value as the target luminance value of each pixel.

According to an exemplary embodiment, said determining a target luminance value of each pixel comprises:

taking a preset luminance value as the target luminance value of each pixel.

According to an exemplary embodiment, said adjusting luminance of some or all of the pixels according to the current luminance value and the target luminance value of each pixel so that a luminance value of each pixel reaches the target luminance value comprises:

obtaining Gamma curve data of the display screen;

adjusting corresponding driving voltages of some or all of the pixels according to the Gamma curve data of the display screen as well as the current luminance value and the target luminance value of each pixel, so that a luminance value of each pixel reaches the target luminance value.

According to an exemplary embodiment, said adjusting corresponding driving voltages of some or all of the pixels according to the Gamma curve data of the display screen as well as the current luminance value and the target luminance value of each pixel so that a luminance value of each pixel reaches the target luminance value comprises:

comparing the current luminance value of each pixel of the display screen with the target luminance value, and if the current luminance value of a pixel is lower than the target luminance value, increasing the driving voltage corresponding to this pixel according to the Gamma curve data of the display screen, so that the luminance value of this pixel reaches the target luminance value;

if the current luminance value of a pixel is higher than the target luminance value, decreasing the driving voltage corresponding to this pixel according to the Gamma curve data of the display screen, so that the luminance value of this pixel reaches the target luminance value.

According to a second aspect of embodiments of the present disclosure, there is provided a system for adjusting luminance of a display screen, comprising:

an obtaining unit for obtaining a current luminance value of each pixel in a preset grayscale image of the display screen, wherein the preset grayscale is any grayscale lower than a preset grayscale threshold;

a determining unit for determining a target luminance value of each pixel;

an adjusting unit for adjusting luminance of some or all of the pixels according to the current luminance value and the target luminance value of each pixel, so that a luminance value of each pixel reaches the target luminance value.

According to an exemplary embodiment, the system further comprises:

a judging unit for judging whether a display effect of the display screen meets a preset display effect after the adjusting unit adjusts luminance of some or all of the pixels; and

a control unit for controlling, when the judging unit determines that the display effect of the display screen does not meet the preset display effect, the obtaining unit to re-obtain a current luminance value of each pixel in a preset grayscale image of the display screen, the determining unit to re-determine a target luminance value of each pixel, and the adjusting unit to adjust luminance of some or all of the pixels according to the current luminance value of each pixel re-obtained by the obtaining unit and the target luminance value re-determined by the determining unit, so that a luminance value of each pixel reaches the re-determined target luminance value.

According to an exemplary embodiment, the preset grayscale threshold is any one of L6˜L10.

According to an exemplary embodiment, the obtaining unit further comprises:

a setting module for setting a number of pixels collected by a CCD camera according to a resolution of the display screen;

a collection module for collecting a current luminance value of each pixel of the display screen by utilizing the set CCD camera.

According to an exemplary embodiment, the determining unit is further for:

determining a current maximum luminance value according to the current luminance value of each pixel of the display screen, and taking the current maximum luminance value as the target luminance value of each pixel.

According to an exemplary embodiment, the determining unit is further for:

obtaining a current average luminance value of the pixels according to the current luminance value of each pixel of the display screen, and taking the average luminance value as the target luminance value of each pixel.

According to an exemplary embodiment, the determining unit is further for:

taking a preset luminance value as the target luminance value of each pixel.

According to an exemplary embodiment, the adjusting unit further comprises:

an obtaining unit for obtaining Gamma curve data of the display screen; and

an adjusting unit for adjusting corresponding driving voltages of some or all of the pixels according to the Gamma curve data of the display screen as well as the current luminance value and the target luminance value of each pixel, so that a luminance value of each pixel reaches the target luminance value.

According to an exemplary embodiment, the adjusting module is further for comparing the current luminance value of each pixel of the display screen with the target luminance value, and if the current luminance value of a pixel is lower than the target luminance value, increasing the driving voltage corresponding to this pixel according to the Gamma curve data of the display screen, so that the luminance value of this pixel reaches the target luminance value; or if the current luminance value of a pixel is higher than the target luminance value, decreasing the driving voltage corresponding to this pixel according to the Gamma curve data of the display screen, so that the luminance value of this pixel reaches the target luminance value.

According to a third aspect of embodiments of the present disclosure, there is provided an apparatus for adjusting luminance of a display screen, comprising at least one processor and at least one memory storing computer program code, the at least one memory and the computer program code are configured to, with the at least one processor, cause the apparatus to at least perform the following operations of:

obtaining a current luminance value of each pixel in a preset grayscale image of the display screen, wherein the preset grayscale is any grayscale lower than a preset grayscale threshold;

determining a target luminance value of each pixel;

adjusting luminance of some or all of the pixels according to the current luminance value and the target luminance value of each pixel, so that a luminance value of each pixel reaches the target luminance value.

According to an exemplary embodiment, the at least one memory and the computer program code may be further configured to, with at least one processor, cause the apparatus to at least perform the method according to any one of the preceding exemplary embodiments.

The system and method for adjusting luminance of a display screen according to the exemplary embodiments of the present disclosure first obtain a current luminance value of each pixel in a preset grayscale image of the display screen, then adjust luminance of some or all of the pixels according to the current luminance value of each pixel and a pre-determined target luminance value, so that a luminance value of each pixel reaches the target luminance value. As can be seen, the scheme for adjusting luminance according to the exemplary embodiments of the present disclosure can improve the luminance uniformity of a liquid crystal display screen, so that the liquid crystal display screen can restore true display information in a low luminance mode.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart of a method for adjusting luminance of a display screen provided according to Embodiment 1;

FIG. 2 is a flowchart of a method for adjusting luminance of a display screen provided according to Embodiment 2;

FIG. 3 is a flowchart of a method for adjusting luminance of a display screen provided according to Embodiment 3;

FIGS. 4a-4c are flowcharts of a method for adjusting luminance of a display screen provided according to Embodiment 4;

FIG. 5 is a flowchart of a method for adjusting luminance of a display screen provided according to Embodiment 5;

FIG. 6 is a flowchart of a method for adjusting luminance of a display screen provided according to Embodiment 6;

FIG. 7 is a schematic structural diagram of a system for adjusting luminance of a display screen provided according to Embodiment 7;

FIG. 8 is a schematic structural diagram of a system for adjusting luminance of a display screen provided according to Embodiment 8;

FIG. 9 is a schematic structural diagram of a system for adjusting luminance of a display screen provided according to Embodiment 9;

FIG. 10 is a schematic structural diagram of a system for adjusting luminance of a display screen provided according to Embodiment 11.

Corresponding reference numerals indicate corresponding parts or features throughout the several views of the drawings.

### DETAILED DESCRIPTION

Example embodiments will now be described more fully with reference to the accompanying drawings.

### Embodiment 1

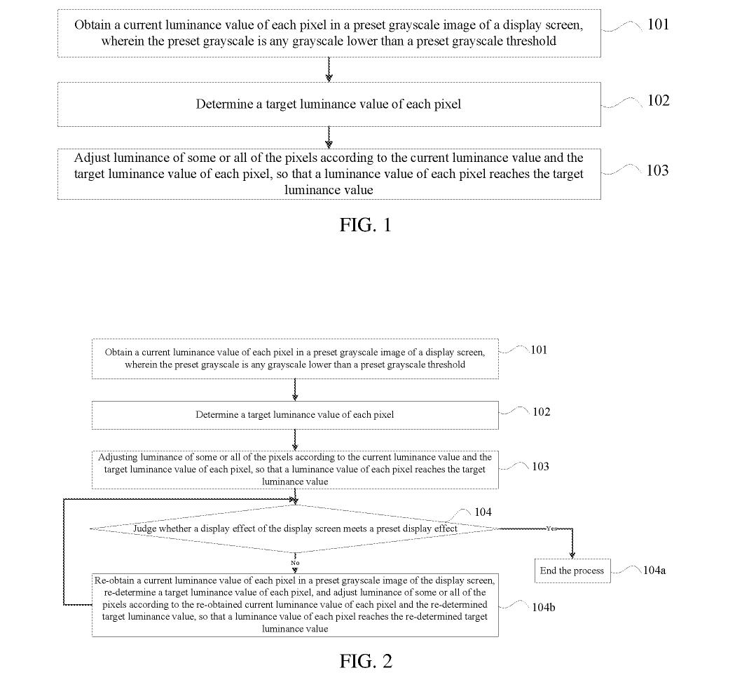

FIG. 1 shows a flowchart of a method for adjusting luminance of a display screen provided according to Embodiment 1. As shown in FIG. 1, the method for adjusting luminance of a display screen provided according to Embodiment 1 comprises the following steps:

Step 101: obtaining a current luminance value of each pixel in a preset grayscale image of a display screen, wherein the preset grayscale is any grayscale lower than a preset grayscale threshold.

For example, grayscales generally comprise L0˜L255, a total of 256, and in practical applications, the preset grayscale may be a grayscale with a low value like L0, L1, L2, etc.

This step defines that the preset grayscale is any grayscale lower than the preset grayscale threshold. For example, the preset grayscale threshold may be any one of L6 L10, and when the preset grayscale threshold is L6, the preset grayscale may be any one of L0, L1, L2, L3, L4 and L5.

Step 102: determining a target luminance value of each pixel.

In this step, a variety of ways may be used to determine the target luminance value of each pixel, and the specific determination ways may be found in the subsequent description of embodiments.

Step 103: adjusting luminance of some or all of the pixels according to the current luminance value and the target luminance value of each pixel, so that a luminance value of each pixel reaches the target luminance value.

The method for adjusting luminance of a display screen according to Embodiment 1 first obtains a current luminance value of each pixel in a preset grayscale image of a display screen, then adjusts luminance of some or all of the pixels according to the current luminance value of each pixel and a pre-determined target luminance value, so that a luminance value of each pixel reaches the target luminance value. As can be seen, the method for adjusting luminance according to Embodiment 1 can improve the luminance uniformity of a liquid crystal display screen, so that the liquid crystal display screen can restore true display information in a low luminance mode.

### Embodiment 2

Referring to FIG. 2, in the present embodiment, the method for adjusting luminance further comprises, after Step 103 abovementioned, the following steps:

Step 104: judging whether a display effect of the display screen meets a preset display effect; if so, executing Step 104a; otherwise, executing Step 104b and continuing to execute Step 104 until the display effect of the display screen meets the preset display effect.

Step 104a: ending the process.

Step 104b: re-obtaining a current luminance value of each pixel in a preset grayscale image of the display screen, re-determining a target luminance value of each pixel, and adjusting luminance of some or all of the pixels according to the re-obtained current luminance value of each pixel and the re-determined target luminance value, so that a luminance value of each pixel reaches the re-determined target luminance value.

In Step 104b, said re-obtaining a current luminance value of each pixel in a preset grayscale image of the display screen and re-determining a target luminance value of each pixel may have the following meanings:

\textcircled{1} on the premise that the preset grayscale does not change, re-obtaining a current luminance value of each pixel in the preset grayscale image of the display screen (since the luminance value of each pixel has been caused to reach the previously determined target luminance value after Step 103, i.e., the current luminance value of each pixel is the same, then the current luminance value of each pixel may not be obtained, but the luminance value reached previously is used continually), and re-determining a target luminance value of each pixel, which target luminance value is a luminance value different from the previous target luminance value;

\textcircled{2} changing the preset grayscale, obtaining a current luminance value of each pixel in the changed preset grayscale image of the display screen, and re-determining a target luminance value of each pixel in the changed preset grayscale image (which target luminance value may be the same as and may be different from the target luminance value for another preset grayscale).

The method for adjusting luminance of a display screen according to Embodiment 2 judges, after adjusting luminance, whether the display effect with adjusted luminance meets the preset display effect; if not, it is needed to adjust luminance of the display screen again according to the re-obtained current luminance value and the re-determined target luminance value, and continue to judge whether the display effect with adjusted luminance meets the preset display effect, and if still not, then continue to adjust until the display effect of the display screen meets the preset display effect.

For example, judging whether the display effect of the display screen meets the preset display effect may refer to:

displaying one or more preset low-grayscale images through the display screen, judging whether the images displayed on the display screen can restore true image information of the one or more preset low-grayscale images, and if so, determining that the display effect of the display screen meets the preset display effect, otherwise, determining that the display effect of the display screen does not meet the preset display effect.

Because in some application fields, only low-luminance images can be displayed or allowed to display, while there exists a problem that the luminance uniformity of the liquid crystal display screen is worse when displaying low-luminance images, thus the liquid crystal display screen cannot accurately restore the true image information, which may mislead control personnel. For example, an image to be displayed on the liquid crystal display screen is an environment of starry sky in which an aircraft operates, assuming that this image is a low-luminance image, then the liquid crystal display screen will have a worse luminance uniformity when displaying the image, a result of which is that the image information displayed on the liquid crystal display screen is not the information the image truly wants to present, thereby likely misleading the control operations of control personnel viewing the liquid crystal display screen, further likely causing a hazardous situation. The method according to Example 2 may improve this defect and enhance uniformity of luminance display of the display screen by adjusting the luminance value of the display screen until reaching the display effect wanted by the user.

### Embodiment 3

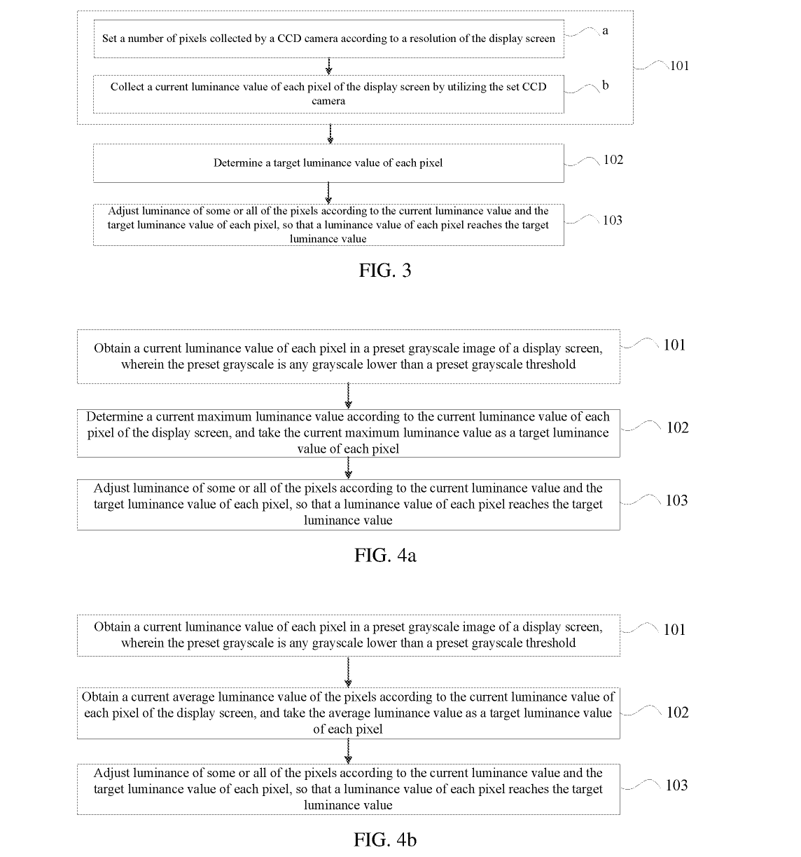

In the present embodiment, an implementation of Step 101 in the above-described embodiment is given. Referring to FIG. 3, Step 101 of obtaining a current luminance value of each pixel in a preset grayscale image of a display screen may comprise the following substeps:

Step a: setting a number of pixels collected by a CCD camera according to a resolution of the display screen;

Step b: collecting a current luminance value of each pixel of the display screen by utilizing the set CCD camera.

In this embodiment, a CCD camera is used to obtain the luminance value of each pixel. For example, the number of pixels collected by the CCD camera is set according to the resolution of the display screen, then the set CCD camera is utilized to collect the current luminance value of each pixel of the display screen, and the collected current luminance value is stored in a register.

### Embodiment 4

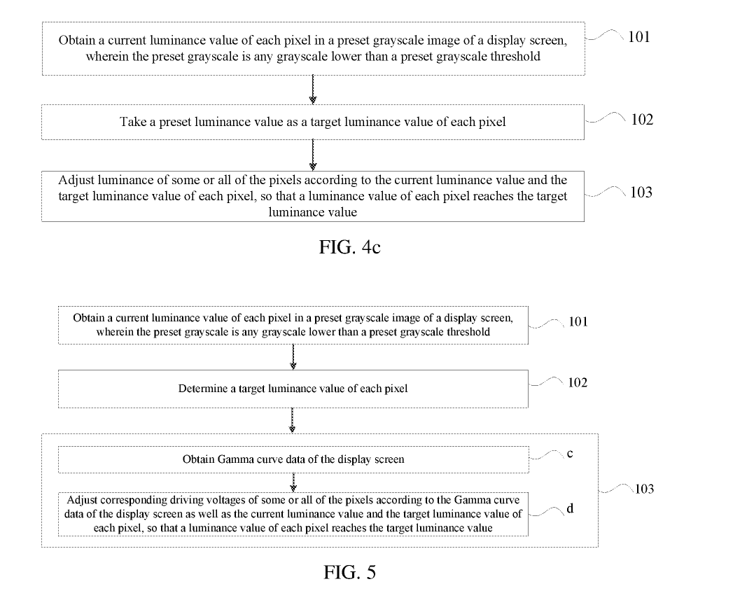

In the present embodiment, referring to FIG. 4a, FIG. 4b and FIG. 4c, three implementations of Step 102 in the abovementioned Embodiment 1.

Referring to FIG. 4a, the first implementation is: determining a current maximum luminance value according to the current luminance value of each pixel of the display screen, and taking the current maximum luminance value as the target luminance value of each pixel.

Referring to FIG. 4b, the second implementation is: obtaining a current average luminance value of the pixels according to the current luminance value of each pixel of the display screen, and taking the average luminance value as the target luminance value of each pixel.

Referring to FIG. 4c, the third implementation is taking a preset luminance value as the target luminance value of each pixel.

In the present embodiment, three methods for determining the target luminance value are given. According to the exemplary embodiment, using the three methods for determining the target luminance can more easily achieve the purpose of enhancing the luminance uniformity of the display screen in a low-grayscale image. Of course, in addition to the three determination methods abovementioned, other determination methods may also be used. For example, a current minimum luminance value is determined according to the current luminance value of each pixel of the display screen, and the current minimum luminance value is taken as the target luminance value of each pixel. Or, a current second largest luminance value is determined according to the current luminance value of each pixel of the display screen (the luminance value merely lower than the maximum luminance value is referred to as the second largest luminance value), and the current second largest luminance value is taken as the target luminance value of each pixel.

### Embodiment 5

In the present embodiment, an exemplary implementation of Step 103 in the above-described embodiment is given. Referring to FIG. 5, Step 103 of adjusting luminance of some or all of the pixels according to the current luminance value and the target luminance value of each pixel so that a luminance value of each pixel reaches the target luminance value may comprise the following substeps:

Step c: obtaining Gamma curve data of the display screen;

Step d: adjusting corresponding driving voltages of some or all of the pixels according to the Gamma curve data of the display screen as well as the current luminance value and the target luminance value of each pixel, so that a luminance value of each pixel reaches the target luminance value.

In this embodiment, the Gamma curve data of the display screen is first collected and stored in a register as compensation coefficients, then the corresponding driving voltages of some or all of the pixels are adjusted according to the Gamma curve data of the display screen as well as the current luminance value and the target luminance value of each pixel so that the luminance value of each pixel reaches the target luminance value, wherein, the collected Gamma curve data are taken as a step-by-step basis in the luminance adjustment procedure.

### Embodiment 6

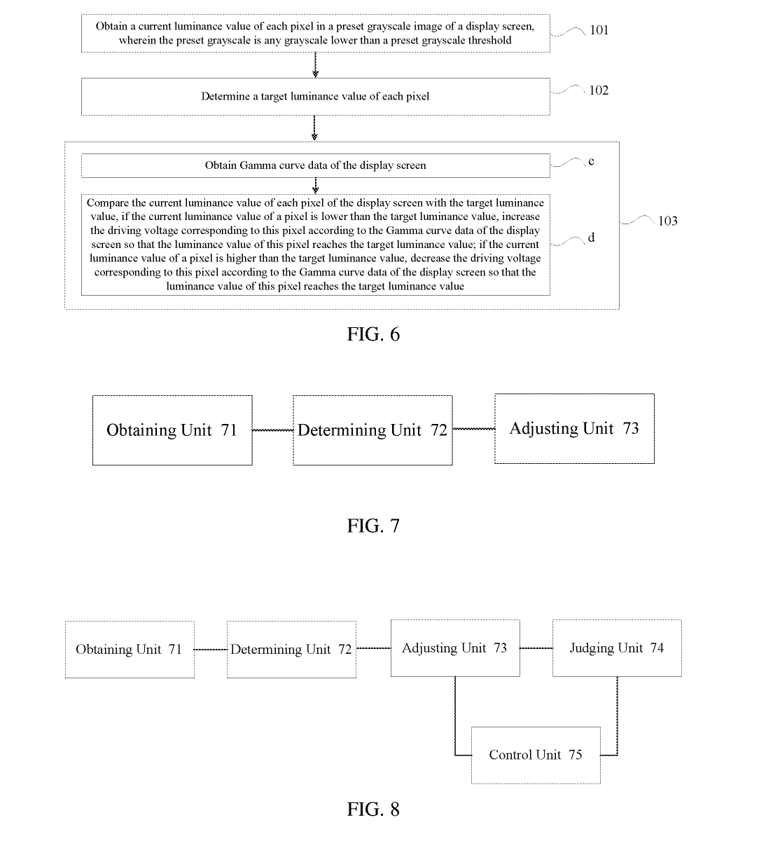

In the present embodiment, an implementation of Step d in Embodiment 5 abovementioned is given. Referring to FIG. 6, an exemplary implementation of Step d abovementioned is as follows:

comparing the current luminance value of each pixel of the display screen with the target luminance value, if the current luminance value of a pixel is lower than the target luminance value, increasing the driving voltage corresponding to this pixel according to the Gamma curve data of the display screen so that the luminance value of this pixel reaches the target luminance value; if the current luminance value of a pixel is higher than the target luminance value, decreasing the driving voltage corresponding to this pixel according to the Gamma curve data of the display screen so that the luminance value of this pixel reaches the target luminance value. In specific implementations, FPGA chip can be used to process the relevant data.

For example, assume that the size of the display screen is 5×5, that is, the display screen has 25 pixels totally. First the current luminance value of each pixel in the L0 grayscale image of the display screen is obtained, and it is assumed that the collected current luminance values are as shown in Table 1 below.

TABLE 1

| | | | | |
|---|---|---|---|---|
| 0.1 | 0.2 | 0.15 | 0.1 | 0.25 |
| 0.15 | 0.1 | 0.1 | 0.15 | 0.2 |
| 0.3 | 0.1 | 0.15 | 0.1 | 0.1 |
| 0.5 | 0.2 | 0.2 | 0.1 | 0.2 |
| 0.1 | 0.3 | 0.2 | 0.4 | 0.25 |

In addition, assume that the determined target luminance value is 0.4, thus it is required to compensate luminance for pixels with a luminance value of other than 0.4, that is, improve luminance of each low-luminance pixel. In the procedure of improving luminance, the collected Gamma curve data are taken as a step-by-step basis for luminance improvement. Since the collected Gamma curve data generally correspond to an exponential function, the target driving voltage of each pixel may be determined according to the collected Gamma curve data, the current luminance value and the target luminance value of each pixel, then the driving voltage value corresponding to each pixel is adjusted according to the target driving voltage of each pixel, thereby causing the luminance value of each pixel to reach the target luminance value.

After luminance adjustment, the overall display effect of the display screen may be observed. If the overall display effect is not satisfactory, it may be adjusted again by changing the target luminance value. For example, the re-determined target luminance value is 0.2, luminance of each pixel is adjusted again, and the effect after this luminance adjustment is observed. If it is satisfactory, then each frame of the images after luminance adjustment is transmitted to the liquid crystal display screen to restore information. If it is not satisfactory, the target luminance value may be re-determined as 0.25 or the like to continue the adjustment. Of course, if an ideal display effect cannot be reached after the target luminance value has been determined many times for adjustment, the current luminance value of each pixel in a L1-grayscale image of the display screen may also be re-obtained, and the target luminance value for the L1-grayscale image is re-determined, then the luminance of each pixel is adjusted again, and the effect after this luminance adjustment is observed.

In summary, the method for adjusting luminance of a display screen according to the above embodiments of the present disclosure greatly improves the luminance uniformity of the liquid crystal display screen with a dark image, provides more realistic image information for operators who need to rely on the content displayed on the display screen to perform corresponding control operations in special circumstances, and meets the requirements of luminance uniformity standard in special fields such as aviation field or the like.

### Embodiment 7

FIG. 7 shows a schematic structural diagram of a system for adjusting luminance of a display screen provided according to Embodiment 7 of the present disclosure. Referring to FIG. 7, the system for adjusting luminance of a display screen provided according to Embodiment 7 of the present disclosure comprises:

an obtaining unit 71 for obtaining a current luminance value of each pixel in a preset grayscale image of a display screen, wherein the preset grayscale is any grayscale lower than a preset grayscale threshold; for example, the preset grayscale threshold is any one of L6 L10;

a determining unit 72 for determining a target luminance value of each pixel;

an adjusting unit 73 for adjusting luminance of some or all of the pixels according to the current luminance value and the target luminance value of each pixel so that a luminance value of each pixel reaches the target luminance value.

The system according to Embodiment 7 can be used to perform the method according to Embodiment 1 abovementioned, with similar principle and technical effect, and will not be described herein again.

### Embodiment 8

In this embodiment, referring to FIG. 8, in addition to the obtaining unit 71, the determining unit 72 and the adjusting unit 73 according to the above embodiment, the system for adjusting luminance of a display screen further comprises:

a judging unit 74 for judging whether a display effect of the display screen meets a preset display effect after the adjusting unit 73 adjusts the luminance of some or all of the pixels; and

a control unit 75 for controlling, when the judging unit 74 determines that the display effect of the display screen does not meet the preset display effect, the obtaining unit 71 to re-obtain a current luminance value of each pixel in a preset grayscale image of the display screen, the determining unit 72 to re-determine a target luminance value of each pixel, and the adjusting unit 73 to adjust luminance of some or all of the pixels according to the current luminance value of each pixel re-obtained by the obtaining unit 71 and the target luminance value re-determined by the determining unit 72 so that a luminance value of each pixel reaches the re-determined target luminance value.

The system according to Embodiment 8 can be used to perform the method according to Embodiment 2 abovementioned, with similar principle and technical effect, and will not be described herein again.

### Embodiment 9

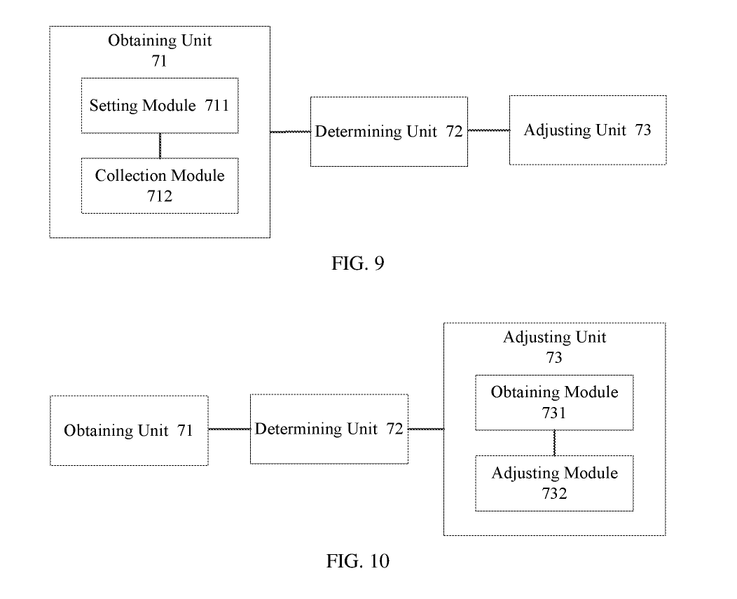

An exemplary implementation of the obtaining unit 71 in Embodiment 7 or Embodiment 8 is given in the present embodiment. In the present embodiment, referring to FIG. 9, the obtaining unit 71 further comprises:

a setting module 711 for setting a number of pixels collected by a CCD camera according to the resolution of the display screen; and

a collection module 712 for collecting a current luminance value of each pixel of the display screen by utilizing the set CCD camera.

The system according to Embodiment 9 can be used to perform the method according to Embodiment 3 abovementioned, with similar principle and technical effect, and will not be described herein again.

### Embodiment 10

Three implementations of the determining unit 72 in Embodiment 7 or Embodiment 8 are given in the present embodiment and are specifically described below.

In a first implementation, the determining unit 72 is further used for determining a current maximum luminance value according to the current luminance value of each pixel of the display screen, and taking the current maximum luminance value as the target luminance value of each pixel.

In a second implementation, the determining unit 72 is further used for obtaining a current average luminance value of the pixels according to the current luminance value of each pixel of the display screen, and taking the average luminance value as the target luminance value of each pixel.

In a third implementation, the determining unit 72 is further used for taking a preset luminance value as the target luminance value of each pixel.

The system according to Embodiment 10 can be used to perform the method according to Embodiment 4 abovementioned, with similar principle and technical effect, and will not be described herein again.

### Embodiment 11

An exemplary implementation of the adjusting unit 73 in Embodiment 7 or Embodiment 8 is given in the present embodiment. In the present embodiment, referring to FIG. 10, the adjusting unit 73 further comprises:

an obtaining module 731 for obtaining Gamma curve data of the display screen; and

an adjusting module 732 for adjusting corresponding driving voltages of some or all of the pixels according to the Gamma curve data of the display screen as well as the current luminance value and the target luminance value of each pixel so that a luminance value of each pixel reaches the target luminance value.

The system according to Embodiment 11 can be used to perform the method according to Embodiment 5 abovementioned, with similar principle and technical effect, and will not be described herein again.

### Embodiment 12

On the basis of Embodiment 11 abovementioned, an exemplary implementation of the adjusting module 732 is given in the present embodiment.

In the present embodiment, the adjusting module 732 is further for comparing the current luminance value of each pixel of the display screen with the target luminance value, and if the current luminance value of a pixel is lower than the target luminance value, increasing the driving voltage corresponding to this pixel according to the Gamma curve data of the display screen, so that the luminance value of this pixel reaches the target luminance value; or if the current luminance value of a pixel is higher than the target luminance value, decreasing the driving voltage corresponding to this pixel according to the Gamma curve data of the display screen, so that the luminance value of this pixel reaches the target luminance value.

The system according to Embodiment 12 can be used to perform the method for adjusting luminance of a display screen according to Embodiment 6 abovementioned, with similar principle and technical effect, and will not be described herein again.

### Embodiment 13

An apparatus for adjusting luminance of a display screen is provided according to Embodiment 13, the apparatus comprising at least one processor and at least one memory storing computer program code, the at least one memory and the computer program code being configured to, with the at least one processor, cause the apparatus to at least perform the following operations of:

obtaining a current luminance value of each pixel in a preset grayscale image of a display screen, wherein the preset grayscale is any grayscale lower than a preset grayscale threshold;

determining a target luminance value of each pixel;

adjusting luminance of some or all of the pixels according to the current luminance value and the target luminance value of each pixel so that a luminance value of each pixel reaches the target luminance value.

The apparatus according to Embodiment 13 may be used to perform the method for adjusting luminance of a display screen according to Embodiment 1 abovementioned, and the at least one memory and the computer program code may be further configured to, with the at least one processor, cause the apparatus to perform the method for adjusting luminance of a display screen according to any one of Embodiment 2 to Embodiment 6, with similar principle and technical effect, and will not be described herein again.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for adjusting luminance of a display screen, comprising:
obtaining a current luminance value of each pixel in a preset grayscale image of a display screen, wherein the preset grayscale is any grayscale lower than a preset grayscale threshold;
determining a target luminance value of each pixel;
adjusting luminance of some or all of the pixels according to the current luminance value and the target luminance value of each pixel, so that a luminance value of each pixel reaches the target luminance value.

2. The method according to claim 1, wherein after adjusting luminance of some or all of the pixels so that the luminance value of each pixel reaches the target luminance value, the method further comprises:
repeating the following steps until a display effect of the display screen meets a preset display effect:
judging whether the display effect of the display screen meets the preset display effect; if not, then re-obtaining a current luminance value of each pixel in the preset grayscale image of the display screen, re-determining a target luminance value of each pixel, and adjusting luminance of some or all of the pixels according to the re-obtained current luminance value of each pixel and the re-determined target luminance value, so that a luminance value of each pixel reaches the re-determined target luminance value.

3. The method according to claim 1, wherein the preset grayscale threshold is any one of L6˜L10.

4. The method according to claim 1, wherein said obtaining a current luminance value of each pixel in a preset grayscale image of a display screen comprises:
setting a number of pixels collected by a CCD camera according to a resolution of the display screen;
collecting a current luminance value of each pixel of the display screen by utilizing the set CCD camera.

5. The method according to claim 1, wherein said determining a target luminance value of each pixel comprises:
determining a current maximum luminance value according to the current luminance value of each pixel of the display screen, and taking the current maximum luminance value as the target luminance value of each pixel.

6. The method according to claim 1, wherein said determining a target luminance value of each pixel comprises:
obtaining a current average luminance value of the pixels according to the current luminance value of each pixel of the display screen, and taking the average luminance value as the target luminance value of each pixel.

7. The method according to claim 1, wherein said determining a target luminance value of each pixel comprises:
taking a preset luminance value as the target luminance value of each pixel.

8. The method according to claim 1, wherein said adjusting luminance of some or all of the pixels according to the current luminance value and the target luminance value of each pixel so that a luminance value of each pixel reaches the target luminance value comprises:
obtaining Gamma curve data of the display screen;
adjusting corresponding driving voltages of some or all of the pixels according to the Gamma curve data of the display screen as well as the current luminance value and the target luminance value of each pixel, so that a luminance value of each pixel reaches the target luminance value.

9. The method according to claim 8, wherein said adjusting corresponding driving voltages of some or all of the pixels according to the Gamma curve data of the display screen as well as the current luminance value and the target luminance value of each pixel so that a luminance value of each pixel reaches the target luminance value comprises:
comparing the current luminance value of each pixel of the display screen with the target luminance value, and if the current luminance value of a pixel is lower than the target luminance value, increasing the driving voltage corresponding to this pixel according to the Gamma curve data of the display screen, so that the luminance value of this pixel reaches the target luminance value;
if the current luminance value of a pixel is higher than the target luminance value, decreasing the driving voltage corresponding to this pixel according to the Gamma curve data of the display screen, so that the luminance value of this pixel reaches the target luminance value.

10. A system for adjusting luminance of a display screen, comprising:
an obtaining unit for obtaining a current luminance value of each pixel in a preset grayscale image of a display screen, wherein the preset grayscale is any grayscale lower than a preset grayscale threshold;
a determining unit for determining a target luminance value of each pixel;
an adjusting unit for adjusting luminance of some or all of the pixels according to the current luminance value and the target luminance value of each pixel, so that a luminance value of each pixel reaches the target luminance value.

11. The system according to claim 10, wherein the system further comprises:
a judging unit for judging whether a display effect of the display screen meets a preset display effect after the adjusting unit adjusts the luminance of some or all of the pixels; and
a control unit for controlling, when the judging unit determines that the display effect of the display screen does not meet the preset display effect, the obtaining unit to re-obtain a current luminance value of each pixel in a preset grayscale image of the display screen, the determining unit to re-determine a target luminance value of each pixel, and the adjusting unit to adjust luminance of some or all of the pixels according to the current luminance value of each pixel re-obtained by the obtaining unit and the target luminance value re-determined by the determining unit, so that a luminance value of each pixel reaches the re-determined target luminance value.

12. The system according to claim 10, wherein the preset grayscale threshold is any one of L6˜L10.

13. The system according to claim 10, wherein the obtaining unit further comprises:
a setting module for setting a number of pixels collected by a CCD camera according to a resolution of the display screen;
a collection module for collecting a current luminance value of each pixel of the display screen by utilizing the set CCD camera.

14. The system according to claim 10, wherein the determining unit is further for:
determining a current maximum luminance value according to the current luminance value of each pixel of the display screen, and taking the current maximum luminance value as the target luminance value of each pixel.

15. The system according to claim 10, wherein the determining unit is further for:
obtaining a current average luminance value of the pixels according to the current luminance value of each pixel of the display screen, and taking the average luminance value as the target luminance value of each pixel.

16. The system according to claim 10, wherein the determining unit is further for:
taking a preset luminance value as the target luminance value of each pixel.

17. The system according to claim 10, wherein the adjusting unit further comprises:
an obtaining unit for obtaining Gamma curve data of the display screen; and
an adjusting unit for adjusting corresponding driving voltages of some or all of the pixels according to the Gamma curve data of the display screen as well as the current luminance value and the target luminance value of each pixel, so that a luminance value of each pixel reaches the target luminance value.

18. The system according to claim 17, wherein the adjusting module is further for comparing the current luminance value of each pixel of the display screen with the target luminance value, and if the current luminance value of a pixel is lower than the target luminance value, increasing the driving voltage corresponding to this pixel according to the Gamma curve data of the display screen, so that the luminance value of this pixel reaches the target luminance value; or if the current luminance value of a pixel is higher than the target luminance value, decreasing the driving voltage corresponding to this pixel according to the Gamma curve data of the display screen, so that the luminance value of this pixel reaches the target luminance value.

19. An apparatus for adjusting luminance of a display screen, comprising at least one processor and at least one memory storing computer program code, the at least one memory and the computer program code being configured to, with the at least one processor, cause the apparatus to at least perform the following operations of:
obtaining a current luminance value of each pixel in a preset grayscale image of a display screen, wherein the preset grayscale is any grayscale lower than a preset grayscale threshold;
determining a target luminance value of each pixel;
adjusting luminance of some or all of the pixels according to the current luminance value and the target luminance value of each pixel, so that a luminance value of each pixel reaches the target luminance value.
